(19) United States
(12) Patent Application Publication
(10) Pub. No.: US 2026/0111943 A1
(43) Pub. Date: Apr. 23, 2026

(54) HYBRID PREDICTIVE AND GENERATIVE ARTIFICIAL INTELLIGENCE DECISION LOGIC FOR ORCHESTRATING AN AUTONOMOUS WORKFLOW

(71) Applicant: Westlake Epoxy Inc., Houston, TX (US)

(72) Inventors: Jian YANG, Houston, TX (US); Michael DESSAUER, Houston, TX (US); Justin CARLIN, Houston, TX (US); Ryan NOLL, Houston, TX (US); Constantyn CHALITSIOS, Houston, TX (US)

(21) Appl. No.: 19/185,776

(22) Filed: Apr. 22, 2025

Related U.S. Application Data
(60) Provisional application No. 63/710,293, filed on Oct. 22, 2024.

(51) Int. Cl. G06Q 30/0601; G06F 40/30; G06Q 30/0201

(52) U.S. Cl. CPC G06Q 30/0631; G06F 40/30; G06Q 30/0206

(57) ABSTRACT

Embodiments of the present disclosure generally relate to methods for autonomous orchestration of a data labeling workflow. Embodiments include generating, using a generative machine learning model, a natural language description of input data. Embodiments include identifying candidate labels that are semantically similar to the natural language description of the input data. Embodiments include providing natural language descriptions of the candidate labels and the natural language description of the input data to a language processing machine learning model. Embodiments include receiving an output from the language processing machine learning model in response to the natural language descriptions of the candidate labels and the natural language description of the input data, wherein the output indicates a selected label from the candidate labels. Embodiments include validating the output based on an alternative label determination technique. Embodiments include associating the selected label with the input data based on the validating.

### CROSS-REFERENCE TO RELATED APPLICATION(S)

This application claims benefit of and priority to U.S. Provisional Patent Application Ser. No. 63/710,293, filed Oct. 22, 2024, herein incorporated by reference in its entirety as if fully set forth below and for all applicable purposes.

### FIELD

Embodiments of the present disclosure generally relate to techniques for using a hybrid of predictive logic and generative artificial intelligence (AI) logic to orchestrate an autonomous workflow such as a data labeling workflow.

### BACKGROUND

Vast amounts of data are processed in computing systems every day. In many cases, it is useful to perform automated workflows using such data such as to make predictions based on such data. Example automated workflows may involve predicting classifications or other labels to associate with particular data items and/or to inform determinations based on such data items. Existing techniques for performing such automated workflows have various technical drawbacks. For example, conventional machine learning models such as classification models are of relatively limited utility in domain-specific applications due to lack of sufficient high quality data to capture the complete complexity in such applications, and often have low levels of confidence for certain types of input data. Language processing machine learning models such as large language models (LLMs) often have difficulty interpreting domain-specific language that frequently appears in domain-specific data, and have limited ability to consider context when there is a vast amount of data that could potentially be relevant. Even if a language processing machine learning model has the ability to process large amounts of context data, there is significant cost in computing resources associated with such processing, and technical issues such as “catastrophic forgetting” can hinder the performance of such a model. Furthermore, there is a lack of proper decision logic for assessing the confidence of outputs generated using machine learning techniques, resulting in significant amounts of manual intervention in many existing techniques.

Thus, there is a need in the art for improved techniques of performing automated workflows.

### SUMMARY

Embodiments of the present disclosure generally relate to methods for autonomous orchestration of a data labeling workflow. Unlike conventional technologies, embodiments described herein involve a hybrid approach that employs conventional classification machine learning technology and generative machine learning technology in a dynamically orchestrated and validated process by which a solution space is automatically enriched and honed and a determination is made with a high level of confidence while minimizing computing resource utilization.

In an embodiment is provided a method for autonomous orchestration of a data labeling workflow. The method may comprise: generating a prediction based on input data using a classification machine learning model; performing, based on a confidence score associated with the prediction, a generative artificial intelligence (AI) process, comprising: generating, using a generative machine learning model, a natural language description of the input data and relevant context; selecting a set of candidate labels based on the natural language description of the input data; providing natural language descriptions of the set of candidate labels and the natural language description of the input data to a language processing machine learning model; and assigning a label to the input data based on the language processing machine learning model outputting the label in response to the natural language descriptions of the set of candidate labels and the natural language description of the input data; and performing an action based on the assigning of the label to the input data.

In another embodiment is provided a method for autonomous orchestration of a data labeling workflow. The method may comprise: generating, using a generative machine learning model, a natural language description of input data; identifying candidate labels that are semantically similar to the natural language description of the input data; providing the candidate labels and the natural language description of the input data to a language processing machine learning model; receiving an output from the language processing machine learning model in response to the candidate labels and the natural language description of the input data, wherein the output indicates a selected label from the candidate labels; validating the output based on an alternative label determination technique; and associating the selected label with the input data based on the validating.

In another embodiment is provided a method for autonomous orchestration of a transaction classification workflow. The method may comprise: determining a predicted classification for a transaction using a classification model; identifying candidate classifications for the transaction from a set of classifications based on a semantic comparison of a description of the transaction with descriptions of the candidate classifications; using a language processing machine learning model to determine a selected classification from the candidate classifications for the transaction; and associating the selected classification with the transaction based on comparing the selected classification with the predicted classification.

In another embodiment is provided a method for autonomous orchestration of an item classification workflow. The method may comprise: identifying candidate classifications for an item from a set of classifications based on a semantic comparison of a description of the item with descriptions associated with the set of classifications, wherein the candidate classifications include a configured number of highest ranked classifications from the set of classifications based on rankings assigned from the semantic comparison; using a large language model (LLM) to determine a selected classification from the candidate classifications for the item; associating the selected classification with the item; and performing an action with respect to the item based on the associating.

In other embodiments, a computing system may be configured to perform any of the above methods. In some embodiments, a computing system comprises one or more processors and a memory storing instructions that, when executed using the one or more processors, cause the computing system to perform any of the methods described above and/or below. Certain embodiments include a non-transitory computer readable medium storing instructions that, when executed using one or more processors of a computing system, cause the computing system to perform any of the methods described above and/or below.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a flowchart showing selected aspects of a process for automated workflow orchestration according to at least one embodiment.

FIG. 2 is an illustration of example aspects related to predictive techniques for automated workflow orchestration according to at least one embodiment.

FIG. 3 is an illustration of example aspects related to language model based enrichment for automated workflow orchestration according to at least one embodiment.

FIG. 4 is an illustration of example aspects related to solution semantic ranking for automated workflow orchestration according to at least one embodiment.

FIG. 5 is an illustration of example aspects related to utilizing a language model as a judge for automated workflow orchestration according to at least one embodiment.

FIG. 6 is a flowchart depicting example operations related to automated workflow orchestration according to at least one embodiment.

FIG. 7 is a diagram depicting an example computing system related to automated workflow orchestration according to at least one embodiment.

### DETAILED DESCRIPTION

Embodiments described herein generally relate to techniques for automated workflow orchestration through a hybrid artificial intelligence (AI) based approach. Embodiments of the present disclosure enable the accurate, resource-efficient, and dynamic automated determination of labels such as classifications for particular data items in a way that is not possible with existing techniques. Advantageously, aspects of the present disclosure produce results that have a higher level of confidence than those produced by prior techniques while minimizing computing resource utilization.

According to certain aspects, a multi-stage process is performed in order to determine a label for a data item, such as a classification for a transaction or other type of information. A first stage may involve utilizing a predictive technique such as a conventional machine learning model to predict a label (e.g., classification) for the data item. For example, a tree-based classification model, a neural network, or the like may be used to predict a label based on one or more features related to the data item. A confidence score may be output by such a model in connection with the predicted label, and the confidence score may be used to determine whether to automatically assign the predicted label to the data item or, alternatively, to proceed with a generative AI process (e.g., if the confidence score is below a threshold).

A second stage may involve various steps related to utilizing generative AI technology to determine a potential label for the data item. For example, a language processing machine learning model such as an LLM or other type of generative model may be used to automatically generate a natural language description of the data item, such as a description that is context-rich, human readable, and does not include domain-specific or technical jargon. For instance, such a model may be provided with the data item (e.g., one or more features of the data item) along with a prompt that instructs the model to generate a natural language description that has certain characteristics. The generated natural language description may then be used to identify candidate labels for the data item. For example, an embedding of the natural language description may be generated (e.g., using an embedding model) and compared to embeddings associated with a set of natural language descriptions of potential labels through a semantic comparison process. In some aspects, embeddings of descriptions associated with different possible labels are stored in a vector store, and the embedding of the natural language description of the data item is compared to those stored embeddings in the vector store in order to identify one or more matches (e.g., a top n matches, where n may be configurable) based on distances (e.g., cosine similarities or other Euclidean distance measurements) between embeddings. Labels associated with embeddings that were included in the one or more best matches may be used as candidate labels. In some cases, the candidate labels may be ranked based on degrees of similarity of their corresponding embeddings to the embedding of the natural language description of the data item.

The candidate labels (which may be ranked) may then be provided to a language processing machine learning model, which may be the same model as that used to generate the natural language description or may be a different model, along with the natural language description of the data item and a prompt instructing the language processing machine learning model to act as a judge and select a best label for the data item from the candidate labels. The language processing machine learning model may also be prompted to output an explanation that provides reasoning for why a particular label was selected by the model. The language processing machine learning model may then output a selected label and, in some aspects, an associated explanation.

In a third stage, the selected label output by the language processing machine learning model may be validated based on comparing the selected label to the predicted label from the first stage. For example, if the selected label matches the predicted label, then operations may proceed with automatically assigning the selected label to the data item with a high level of confidence. If the selected label does not match the predicted label but is in partial agreement with the predicted label, such as if the predicted label is in the list of candidate labels that leads to the selected label or the selected label and the predicted label are in a same higher-level category or otherwise are associated with one another in one or more particular ways, then operations may proceed with automatically assigning the selected label to the data item with a lower level of confidence, such as providing a notification along with the selected label indicating that the selected label should be manually reviewed. If the selected label does not match the predicted label and does not meet any condition that would allow it to be considered in partial agreement with the predicted label, then operations may proceed without automatically assigning the selected label to the data item, such as proceeding to a human control process (e.g., presenting the data item to a user for manual labeling, such as providing the user with the selected label as a low confidence suggestion).

Once a data item is assigned a label using automated workflow orchestration techniques described herein, the label may allow the data item to be automatically processed in a computing system for a variety of purposes. For example, a label assigned to a data item may be used to automatically update a workflow of a software application, populate a variable, provide content via a user interface, recommend the data item to a particular user, categorize the data item, generate a financial prediction related to the item, generate a market-related prediction regarding the data item, perform automated procurement analysis with respect to the data item (e.g., if the data item is a record of a transaction related to one or more merchants or is a data set related to a product, service, entity, and/or the like).

Techniques described herein accomplish a variety of technical improvements. For example, while some conventional techniques for performing automated workflows may involve the use of conventional machine learning models such as classification models or neural networks, such techniques by themselves are limited in their ability to analyze domain-specific information and language, and have limited levels of confidence for domain-specific predictions. Furthermore, while some existing techniques for performing automated workflows may involve the use of language processing machine learning models such as LLMs, such techniques by themselves have limited context windows (e.g., such models can only process limited amounts of context information), do not typically perform well when input data includes domain-specific terminology, sometimes suffer from “catastrophic forgetting” issues (e.g., when a model abruptly and drastically forgets previously learned information upon learning new information), and often require large amounts of computing resources, particularly when provided with large amounts of potentially relevant context information. Such technical issues often result in the involvement of humans in orchestrating such workflows, which can involve large amounts of time and labor to manually evaluate large amounts of data, and typically requires significant amounts of domain-specific expertise.

Techniques described herein overcome these challenges through a hybrid multi-stage process that involves conventional machine learning techniques, language processing machine learning techniques, dynamic enrichment and honing of input data, and automated validation based on comparing results of different techniques. By performing an initial prediction of a label for a data item using a conventional machine learning model and determining based on a confidence score output by such a model whether to proceed with further processing through a generative AI process, techniques described herein avoid the use of such a generative AI process (and associated computing resource utilization) when the conventional model produces a high confidence result, and create a reference point (the predicted label) to which an ultimate result of a generative AI process can be compared for automated validation purposes if such a generative AI process if performed. Furthermore, during a generative AI processing stage, by utilizing a language processing machine learning model to automatically generate a natural language description of a data item that is context-rich and relatively free of domain-specific jargon, techniques described herein allow candidate labels to be automatically identified through a semantic search in a manner that is more contextualized and accurate than would be enabled by existing techniques. Providing such dynamically selected candidate labels (instead of all potentially relevant labels and/or context information) and such a natural language description of the data item (instead of the only the underlying data item itself and/or all potentially relevant context information) to a language processing machine learning model enables the model to operate in a more resource-efficient manner (based on the reduced amount of input data) and to make a more accurate and informed determination based on being provided with a focused and enriched set of input data that is tailored to the expertise of language processing machine learning models (e.g., processing natural language rather than technical jargon and other types of input data). Validating outputs from a language processing machine learning model based on predictions from a conventional machine learning model allow for increased confidence in automatically selected labels, and limit manual review to situations where confidence is low, significantly reducing the amount of such human control.

Thus, aspects of the present disclosure allow for orchestration of an automated workflow, such as involving data labeling, in a dynamic and resource-efficient manner that avoids unnecessary utilization of computing resources, improves accuracy and confidence of automatically determined results, and reduces instances in which manual review is required.

In particular use cases, such as automatically analyzing data for procurement purposes, techniques described herein significantly improve the efficiency and accuracy of such a process. Experimental results indicate that techniques described herein exceed typical human accuracy benchmarks by approximately 10-15%, achieve 54% task autonomy with 93.7% accuracy, and greatly enhance decision making speed when manual review is requested (e.g., based on providing the user with AI generated descriptions and reasoning).

In some aspects, autonomous orchestration of a data labeling workflow as described herein, such as applied to a large volume of data processing, may be sped up by applying parallel processing or multi-thread processing to initiate multiple computation cores to process multiple data entries simultaneously or quasi-simultaneously. For example, a multi-stage process described herein for data labeling may be performed for each of a plurality of input data items in parallel using such a parallel processing or multi-thread processing technique, further improving efficiency.

In a particular example, tests were performed using techniques described herein to process a large volume batch of records. In this example, 352,071 records were processed in a batch size of 400 threads. Test results indicated that the processing time per record was 0.31 seconds, demonstrating the scalability and efficiency of techniques described herein in a batch processing environment, and showcasing the ability of techniques described herein to process large volumes of data accurately and autonomously.

In the tests, the use of the hybrid predictive and generative technique described herein resulted in an overall accuracy of 72%, with 75% of the records being labeled autonomously with level 1 confidence, and with the level1 autonomous labeling process having an accuracy of 88%. These results demonstrate how aspects of the present disclosure provide reliable results and improved efficiency, with a large percentage of the workload being processed autonomously with a high level of accuracy.

By way of comparison, tests indicated that utilizing a predictive machine learning only approach (e.g., only a predictive model without any of the generative machine learning or hybrid aspects described herein) resulted in an overall accuracy of 76% with only 64% of the records being labeled autonomously. These results demonstrate that while the predictive machine learning only approach has a similar overall accuracy to the hybrid approach described herein, the predictive machine learning only approach has a significantly lower rate of high confidence outputs that result in autonomous labeling than the hybrid approach (64% versus 75%). Further, tests indicated that utilizing a generative machine learning only approach (e.g., only a generative model without any of the predictive machine learning or hybrid aspects described herein) resulted in an overall accuracy of only 36%. These results demonstrate that domain-specific data is crucial for using a generative model for domain specific tasks, and that the hybrid techniques described herein result in a dramatic improvement in accuracy as compared to a generative machine learning only approach. Thus, by greatly increasing the instances in which data items can be autonomously processed with a high level of accuracy as compared to existing predictive or generative techniques, aspects of the present disclosure result in multiple demonstrable technical improvements to the field of performing automated workflows, including improvements in efficiency, scalability, and accuracy.

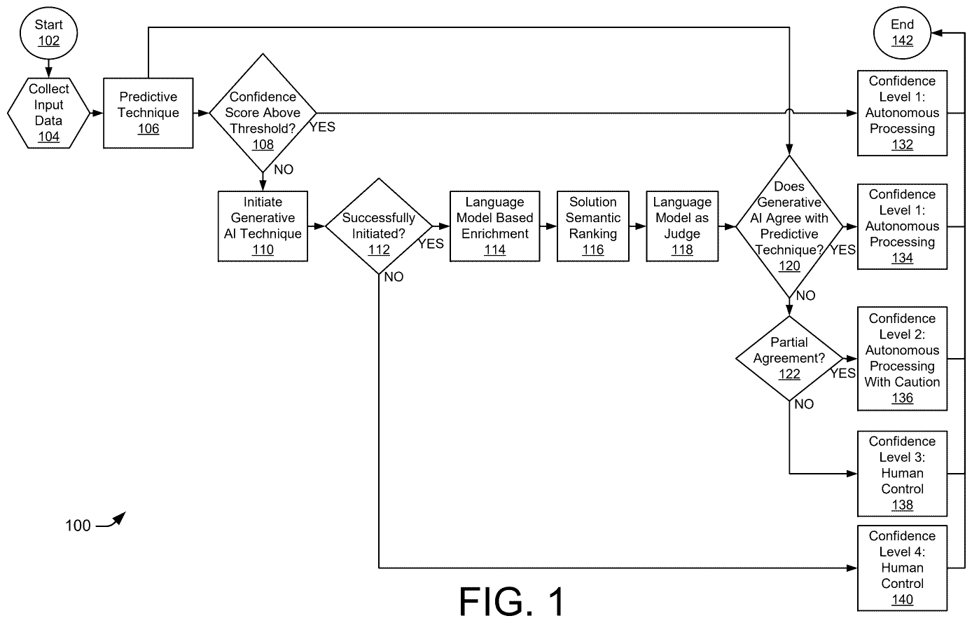

FIG. 1 is a flowchart 100 showing selected aspects of a process for automated workflow orchestration according to at least one embodiment. Embodiments and implementations of the process depicted in flowchart 100 may be combined with other embodiments described herein.

The process may begin at 102 (e.g., the start of the process), and may proceed to collecting input data 104. Collecting input data 104 may involve, for example, receiving/retrieving a data item and/or its associated information. For example, the data item may be a transaction record, a user profile, a business profile, a set of data about an entity such as a product or service, a content item (e.g., image, video, text, and/or the like), and/or the like. Information included in the input data may include one or more attributes that are part of and/or related to a data item. In some examples, the input data includes a vendor name, an asset description, manufacturing information, and/or the like (e.g., from a transaction record).

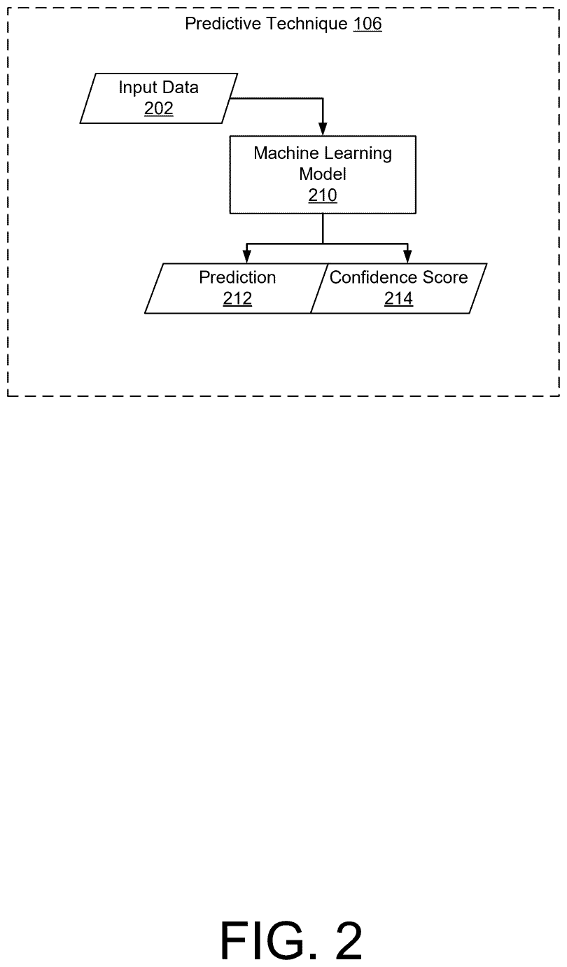

A predictive technique 106 may then be used to predict a label for the input data. Predictive technique 106 is described in more detail below with respect to FIG. 2, and may include, for example, providing inputs based on the input data to a conventional machine learning model such as a tree-based classification model or neural network and receiving a predicted label from the model in response. The model may also output a confidence score associated with the predicted label.

A determination is made at 107 of whether the confidence score associated with the predicted label (e.g., predicted using predictive technique 106) exceeds a threshold. If the confidence score exceeds the threshold, then operations may proceed at autonomous processing 132 with a high confidence level (e.g., a confidence level of 1 on a scale of 1-4, which is only included as an example). Autonomous processing 132 may involve automatically assigning the predicted label to the input data without manual review. The automatically assigned label may then allow the input data to be automatically processed in a variety of ways. If the confidence score does not exceed the threshold, then operations may proceed with initiating a generative AI technique 110. Initiating the generative AI technique 110 may involve initiating a process that includes several subsequent steps involving the use of generative machine learning technology.

A determination is made at 112 of whether the generative AI technique was successfully initiated. If the generative AI technique was not successfully initiated then operations may proceed to human control 140 with a low level of confidence (e.g., a confidence level of 4 on a scale of 1-4, which is only included as an example). Human control 140 may involve, for example, presenting a user with the input data and a set of potential labels (e.g., including the predicted label that was determined using predictive technique 106) and prompting the user to select a label for the input data. If the generative AI technique was successfully initiated then operations may proceed to language model based enrichment 114.

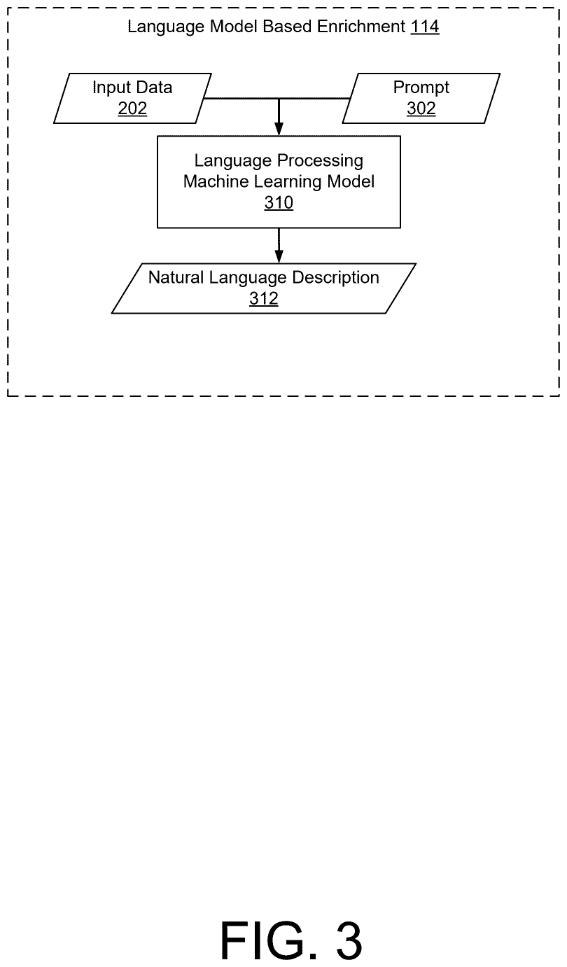

Language model based enrichment 114 is described in more detail below with respect to FIG. 3, and may involve, for example, using a language processing machine learning model such as an LLM or other type of generative model to automatically generate a natural language description of the input data, which may include relevant context. For instance, the language processing machine learning model may be provided with the input data along with a prompt that instructs the model to generate a natural language description according to one or more criteria, such as excluding or minimizing domain-specific terminology, generating the description from a particular perspective (e.g., an expert in a particular domain), using human readable language, providing additional context that does not exist in original description, and/or the like. Solution semantic ranking 116 may then be performed based on the generated natural language description.

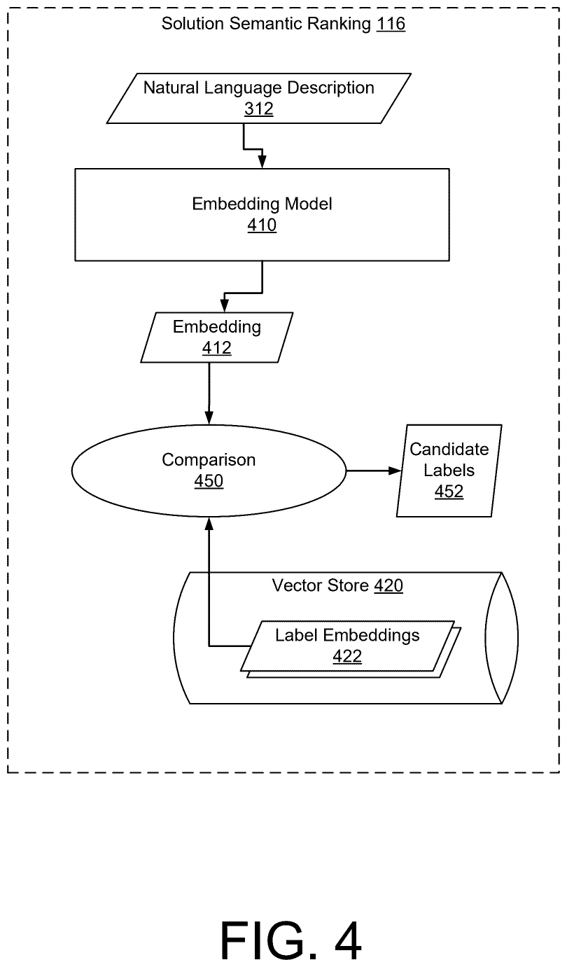

Solution semantic ranking 116 is described in more detail below with respect to FIG. 4, and may include, for example, generating an embedding of the natural language description of the input data and comparing that embedding to embeddings associated with a set of labels in order to identify candidate labels (e.g., which may include one or more labels that are associated with embeddings that are determined to be similar to the embedding of the natural language description of the input data, such as based on cosine similarity). The embeddings associated with the labels may be embeddings of descriptions associated with the labels, and may be stored in a searchable data storage entity (e.g., a vector store). In one example, the candidate labels include a top n matching labels (e.g., labels associated with embeddings that are determined to be most similar to or closest to the embedding of the natural language description of the input data), where n may be configurable. The process may then proceed to language model as a judge 118.

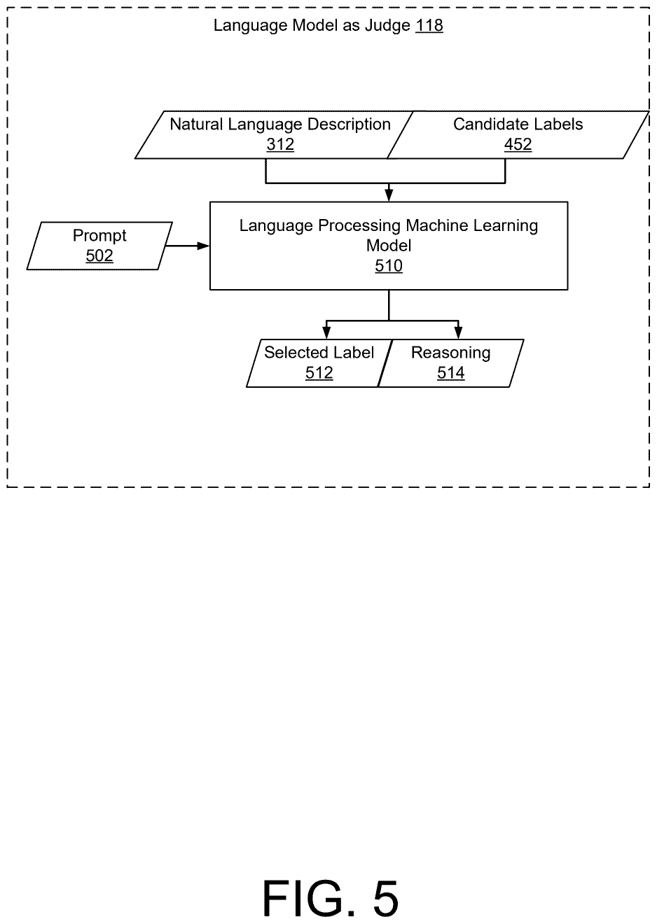

Language model as a judge 118 is described in more detail below with respect to FIG. 5, and may include, for example, providing the candidate labels (e.g., and/or their associated descriptions) to a language processing machine learning model along with the natural language description of the input data (e.g., and, in some aspects, the input data itself) and a prompt that instructs the model to select a label from the candidate labels for the input data. In some aspects, the prompt also instructs the model to output an explanation associated with the selected label, such as including reasoning for why the selected label was selected by the model. The language processing machine learning model used at language model as a judge 118 may the same as or different than the language processing machine learning model used at language model based enrichment 114. The language processing machine learning model may output a selected label based on the inputs, and may also output an explanation associated with the selected label.

A decision is made at 120 of whether the generative AI result (e.g., the selected label output during language model as a judge 118) agrees with (e.g., matches) the result of the predictive technique (e.g., the predicted label determined using predictive technique 106). If the results agree with one another, then operations may proceed to autonomous processing 134 with a high level of confidence (e.g., a confidence level of 1 on a scale of 1-4, which is only included as an example). Autonomous processing 134 may involve automatically assigning the predicted label to the input data without manual review. The automatically assigned label may then allow the input data to be automatically processed in a variety of ways. If the results do not agree with one another, then a determination may be made at 122 of whether the results partially agree with one another.

Partial agreement may mean, for example, that the predicted label and the selected label do not match but belong to a same higher-level category, share one or more particular attributes, are associated with one another in one or more particular ways, are semantically similar to one another, and/or the like. If the results partially agree with one another, then operations may proceed to autonomous processing with caution 136 with a relatively high level of confidence (e.g., a confidence level of 2 on a scale of 1-4, which is only included as an example). Autonomous processing with caution 136 may involve, for example, automatically associating the selected label with the input data and displaying the selected label in connection with the input data to a user with an indication that the label does not have a highest level of confidence and/or otherwise associating the selected label with an indicator that the selected label is not certain. If the results do not partially agree with one another, then operations may proceed to human control 138, with a relatively lower level of confidence (e.g., a confidence level of 3 on a scale of 1-4, which is only included as an example). Human control 138 may involve, for example, presenting a user with the natural language description of the input data (and, in some aspects, the input data itself) and a set of potential labels (e.g., including the predicted label that was determined using predictive technique 106, the selected label that determined using language model as a judge 118, an explanation associated with the selected label, and/or the like, and, in some embodiments, a description of each label that is displayed) and prompting the user to select a label for the input data. Human control 138 may have a relatively higher level of confidence than human control 140 because human control 138 involves displaying the natural language description and/or selected label (and, in some aspects, the associated explanation) generated during the generative AI process while human control 140 does not involve displaying such information (e.g., because human control 140 is performed if the generative AI process is not able to be successfully initiated).

Once a label is assigned to the input data, either at autonomous processing 132, autonomous processing 134, autonomous processing with caution 136, human control 138, or human control 140, the process may end at 142 (e.g., the end of the process).

Further processing may be performed based on such an assigned label. For example, the label assigned to the input data may allow one or more automated determinations to be made, may allow content to be automatically targeted to one or more users, may allow a variable to be automatically populated, may allow a user interface to be updated, may allow an application workflow to be automatically updated, and/or the like. For example, if the input data is a transaction record and the label is a classification relating to procurement, then an automated procurement related prediction, recommendation, or determination may be made based on the label being assigned to the input data.

The process depicted and described with respect to flowchart 100 may be performed for each of a plurality of instances of input data 104 in parallel on multiple processing devices (e.g., cores) or threads, such as using a parallel processing or multi-thread processing technique.

FIG. 2 is an illustration of example aspects related to predictive techniques forautomated workflow orchestration according to at least one embodiment. For example, FIG. 2 depicts functionality related predictive technique 106 of FIG. 1. Embodiments and implementations of functionality depicted and described with respect to FIG. 2 may be combined with other embodiments described herein.

In predictive technique 106, input data 202 may be provided to a machine learning model 210, and machine learning model 210 may output a prediction 212 and a confidence score 214 in response. Input data 202 may correspond to the input data collected at collect input data 104 of FIG. 1. Machine learning model 210 may correspond to predictive technique 106 of FIG. 1. Prediction 212 may represent a predicted label for input data 202, and confidence score 214 may represent a confidence score output by machine learning model 210 in connection with prediction 212.

Machine learning model 210 may be any type of machine learning model capable of generating a prediction and associated confidence score based on input data. For example, machine learning model 210 may be a tree-based classification model, a neural network, a regression model, a support vector machine, or the like. In some aspects, machine learning model 210 may have been trained through a supervised learning process. For example, such a supervised learning process may involve providing training inputs to the model, receiving predictions from the model in response to the training inputs, and iteratively adjusting parameters of the model based on comparing the predictions to labels (e.g., ground truth labels) associated with the training inputs until one or more conditions are met. The one or more conditions may involve, for example, determining whether the predictions produced by the model match the labels, optimizing a cost function, determining whether a measure of error between training iterations is not decreasing or not decreasing more than a threshold amount, and/or the like.

Machine learning model 210 may be re-trained over time based on user feedback and/or based on results of a generative AI process. For example, once a label is confirmed for given input data based on manual review (e.g., human control 136 or 140 of FIG. 1) and/or based on high confidence autonomous processing (e.g., autonomous processing 134 of FIG. 1), then the label may be used as a ground truth label in association with the given input data in a new training data instance that is used to re-train machine learning model 210 through a supervised learning process. Such re-training may enable machine learning model 210 to improve in accuracy over time, further reducing the cases in which the generative AI process is used and thereby further improving the resource efficiency of techniques described herein.

FIG. 3 is an illustration of example aspects related to language model based enrichment for automated workflow orchestration according to at least one embodiment. For example, FIG. 3 depicts functionality related to language model based enrichment 114 of FIG. 1. Embodiments and implementations of functionality depicted and described with respect to FIG. 3 may be combined with other embodiments described herein.

In language model based enrichment 114, input data 202 may be provided to a language processing machine learning model 310 along with a prompt 302, and language processing machine learning model 310 may output a natural language description 312 in response. Input data 202 may correspond to the input data collected at collect input data 104 of FIG. 1. Natural language description 312 may be a description of input data 202 in human readable language that includes contextual information and excludes or minimizes domain-specific terminology that may be included in input data 202. In some aspects, natural language description 312 is a brief string, such as 1-3 sentences.

Language processing machine learning model 310 may be any type of machine learning model capable of generating a natural language description based on input data and a natural language prompt. For example, language processing machine learning model 310 may be a large language model (LLM) or other type of generative machine learning model capable of processing and generating natural language content. In some aspects, language processing machine learning model 310 may have been trained based on a large data set of natural language data to recognize patterns in such data. In certain aspects, language processing machine learning model 310 is a transformer neural network. Language processing machine learning model 310 may have been fine tuned based on domain specific natural language data that relates to a domain of input data 202. A domain generally refers to a subject, field, computing environment, purpose, or the like.

Prompt 302 may instruct language processing machine learning model 310 to generate a natural language description according to particular attributes, such as from a perspective of an expert in a particular domain, excluding or minimizing domain-specific language, being of a certain length or length range, using human readable language, not including reasoning, and/or the like.

In one example, prompt 302 includes the text “As an expert of procurement analysis for a chemical company, please give me a short description of business scope for a given vendor company that serves chemical manufacturing companies. The vendor company name is {company}. Your final response should be a string of the description you generated. Do not include your reasoning.”

In another example, prompt 302 includes the text “As an expert of procurement analysis for a chemical company, please give me a technical, categorical description of a line item in the procurement item sheet. The line item {product or service description} is a product or service of a vendor company {vendor description} that serves the chemical manufacturing plant {plant description}. Your final response should be a string of the description you generated. Do not include your reasoning.”

Language processing machine learning model 310 may generate natural language description 312 according to prompt 302 based on input data 202.

FIG. 4 is an illustration of example aspects related to solution semantic ranking for automated workflow orchestration according to at least one embodiment. For example, FIG. 4 depicts functionality related solution semantic ranking 116 of FIG. 1. Embodiments and implementations of functionality depicted and described with respect to FIG. 4 may be combined with other embodiments described herein.

In solution semantic ranking 117, natural language description 312 (e.g., which may have been generated as described above with respect to FIG. 3) may be provided to an embedding model 410, and embedding model 410 may output an embedding 412 in response.

An embedding generally refers to a vector representation of an entity that represents the entity as a vector in n-dimensional space such that similar entities are represented by vectors that are close to one another in the n-dimensional space. Embeddings may be generated through the use of an embedding model 410, such as a neural network or other type of machine learning model that learns a representation (embedding) for an entity through a training process that trains the neural network or other model based on a data set, such as a plurality of features of a plurality of entities.

In one example, the embedding model 410 comprises a text encoder such as a Bidirectional Encoder Representations from Transformer (BERT) model configured to generate embeddings. BERT models may involve the use of masked language modeling to determine embeddings. In a particular example, embedding model 410 comprises a Sentence-BERT model. In other embodiments, embedding model 410 may involve embedding techniques such as Word2Vec and GloVe embeddings. These are included as examples, and other techniques for generating embeddings are possible.

At comparison 450, embedding 412 is compared to label embeddings 422 from a vector store 420 in order to identify candidate labels 452. Label embeddings 422 may be embeddings (e.g., generated in a similar manner to that discussed above with respect to embedding model 410) of descriptions or other text associated with particular labels (e.g., classifications). Vector store 420 may be a data storage entity, such as a database, and may be searchable, such as based on a semantic similarity search.

In some aspects, comparison 450 involves searching vector store 420 for one or more label embeddings 422 that are semantically similar to (e.g., within a threshold Euclidean distance of) embedding 412. Candidate labels 452 may, for example, include a top n matching embeddings from label embeddings 422 for embedding 412. For instance, the n embeddings from label embeddings 422 that have the smallest Euclidean distance from embedding 412 (e.g., where the embeddings are ranked in order of distance from embedding 412) may be identified as candidate labels 452. In some aspects, n may be a configurable value. More generally, candidate labels 452 may be the labels corresponding to embeddings from label embeddings 422 that are closest to embedding 412.

FIG. 5 is an illustration of example aspects related to utilizing a language model as a judge for automated workflow orchestration according to at least one embodiment. For example, FIG. 5 depicts functionality related to language model as a judge 118 of FIG. 1. Embodiments and implementations of functionality depicted and described with respect to FIG. 5 may be combined with other embodiments described herein.

In language model as a judge 118, natural language description 312 (e.g., which may have been generated as described above with respect to FIG. 3) and candidate labels 452 (e.g., which may have been determined as described above with respect to FIG. 4) are provided to a language processing machine learning model 510 along with a prompt 502, and language processing machine learning model 510 may output a selected label 512 and associated reasoning 514 in response.

Language processing machine learning model 510 may be any type of machine learning model capable of selecting a label from a set of candidate labels based on a natural language description and a natural language prompt. For example, language processing machine learning model 510 may be an LLM or other type of generative machine learning model capable of processing and generating natural language content. Language processing machine learning model 510 may be the same model as or a different model than language processing machine learning model 310 of FIG. 3. In some aspects, language processing machine learning model 510 may have been trained based on a large data set of natural language data to recognize patterns in such data. In certain aspects, language processing machine learning model 510 is a transformer neural network. Language processing machine learning model 510 may have been fine tuned based on domain specific natural language data that relates to a domain associated with natural language description 312. A domain generally refers to a subject, field, computing environment, purpose, or the like.

Prompt 502 may instruct language processing machine learning model 510 to act as a judge and select between the labels in candidate labels 452 as a label for a data item described by natural language description 312. Prompt 502 may also instruct language processing machine learning model 510 to output an explanation of why it selected a particular label (e.g., reasoning 514 may represent such an explanation). In some embodiments, the data item itself is also provided to language processing machine learning model 510 and/or descriptions associated with candidate labels 452 are also provided to language processing machine learning model 510.

Language processing machine learning model 510 may output selected label 512 and reasoning 514 in response to the inputs. Selected label 512 may be a label included in candidate labels 452 that language processing machine learning model 510 determines is a best fit for natural language description 312. Reasoning 514 may include a natural language description of why selected label 512 was selected.

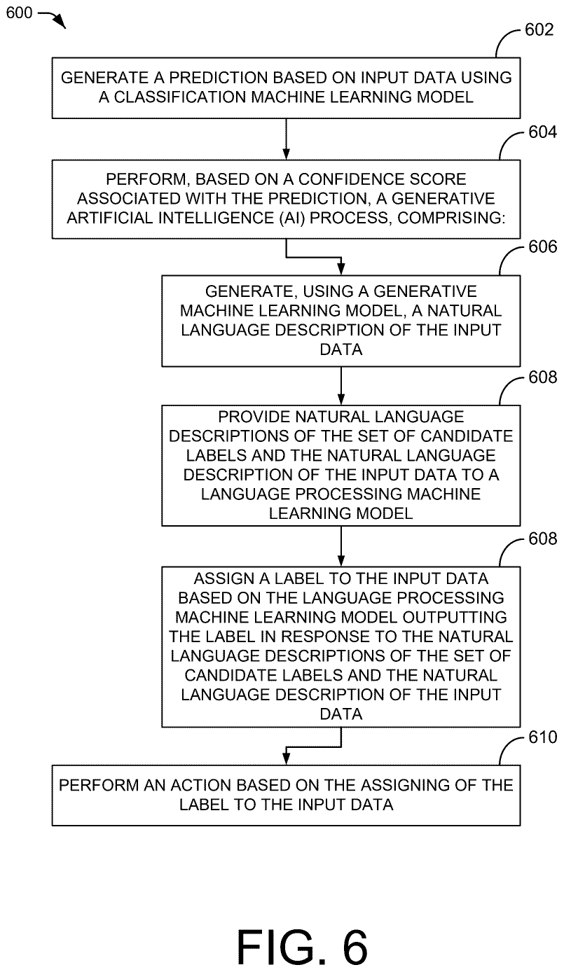

FIG. 6 is a flowchart depicting example operations 600 related to automated workflow orchestration according to at least one embodiment. For example, operations 600 may be performed by one or more components depicted and described above with respect to FIGS. 1-5.

Operations 600 may begin at 602, with generating a prediction based on input data using a classification machine learning model.

Operations 600 may continue at 604, with performing, based on a confidence score associated with the prediction, a generative artificial intelligence (AI) process.

The generative AI process may include, at 606, generating, using a generative machine learning model, a natural language description of the input data. In some aspects, the natural language description of the input data includes relevant context. The relevant context may not have been included in the input data.

The generative AI process may include, at 608, selecting a set of candidate labels based on the natural language description of the input data.

The generative AI process may include, at 610, providing natural language descriptions of the set of candidate labels and the natural language description of the input data to a language processing machine learning model.

The generative AI process may include, at 612, assigning a label to the input data based on the language processing machine learning model outputting the label in response to the natural language descriptions of the set of candidate labels and the natural language description of the input data.

The generative AI process may include, at 614, performing an action based on the assigning of the label to the input data.

In some aspects, the performing of the generative AI process is based on determining that the confidence score associated with the prediction is below a threshold.

In certain aspects, the generating of the natural language description of the input data comprises prompting the generative machine learning model to generate the natural language description in a manner that adds context to the input data and uses human readable natural language.

In some aspects, the assigning of the label to the input data is further based on determining that the label matches the prediction.

In certain aspects, the assigning of the label to the input data is further based on determining that the label does not match the prediction and receiving manual confirmation of the label.

In some aspects, the performing of the action comprises one or more of: updating a workflow of a computing application; populating a variable; or displaying content via a user interface.

In certain aspects, the selecting of the set of candidate labels based on the natural language description of the input data comprises: generating an embedding of the natural language description; comparing the embedding of the natural language description to embeddings of descriptions of a plurality of labels; and selecting the set of candidate labels based on the comparing, wherein the set of candidate labels contains fewer than all of the plurality of labels.

Some aspects further comprise generating an additional prediction based on additional input data using the classification machine learning model, determining, based on a corresponding confidence score associated with the additional prediction exceeding a threshold, not to perform a corresponding generative AI process for the additional input data, and assigning a corresponding label to the additional data based on the additional prediction without performing the corresponding generative AI process.

Other aspects include an autonomous orchestration of a data labeling workflow. Such aspects may include generating, using a generative machine learning model, a natural language description of input data, identifying candidate labels that are semantically similar to the natural language description of the input data, providing the candidate labels and the natural language description of the input data to a language processing machine learning model, receiving an output from the language processing machine learning model in response to the candidate labels and the natural language description of the input data, wherein the output indicates a selected label from the candidate labels, validating the output based on an alternative label determination technique, and associating the selected label with the input data based on the validating.

Certain aspects further comprise receiving, from the language processing machine learning model, a natural language explanation of why the selected label was chosen.

In some aspects, the validating comprises determining whether the selected label matches a label determined using the alternative label determination technique or whether the selected label is within a category associated with the label determined using the alternative label determination technique.

In certain aspects, the validating comprises providing the selected label to a user interface for manual review based on determining that the selected label does not match the label determined using the alternative label determination technique and that the selected label is not within the category associated with the label determined using the alternative label determination technique.

In some aspects, the validating comprises associating an accuracy indicator with the selected label based on determining that the selected label does not match the label determined using the alternative label determination technique and that the selected label is within the category associated with the label determined using the alternative label determination technique.

Other aspects provide a method for autonomous orchestration of a transaction classification workflow. Such aspects may comprise determining a predicted classification for a transaction using a classification model, identifying candidate classifications for the transaction from a set of classifications based on a semantic comparison of a description of the transaction with descriptions of the candidate classifications, using a language processing machine learning model to determine a selected classification from the candidate classifications for the transaction, and associating the selected classification with the transaction based on comparing the selected classification with the predicted classification.

Some aspects include the candidate classifications exclude one or more classifications from the set of classifications.

In certain aspects, the language processing machine learning model outputs the selected classification based on analyzing the descriptions of the candidate classifications and the description of the transaction.

Some aspects further comprise generating the description of the transaction using the language processing machine learning model or a different generative machine learning model based on a prompt indicating that the description should be generated from a perspective of an expert in a particular domain.

In certain aspects, the particular domain is procurement of goods or services in a particular industry.

Other aspects provide a method for autonomous orchestration of an item classification workflow. Such aspects may include identifying candidate classifications for an item from a set of classifications based on a semantic comparison of a description of the item with descriptions associated with the set of classifications, wherein the candidate classifications include a configured number of highest ranked classifications from the set of classifications based on rankings assigned from the semantic comparison, using a large language model (LLM) to determine a selected classification from the candidate classifications for the item, associating the selected classification with the item, and performing an action with respect to the item based on the associating.

In some aspects, the performing of the action comprises one or more of: displaying the item via a user interface; recommending the item to a user; determining pricing information associated with the item; determining market information associated with the item; or determining material information associated with the item.

Certain aspects further comprise utilizing parallel processing or multi-thread processing to determine a corresponding selected classification for a different item while determining the selected classification for the item.

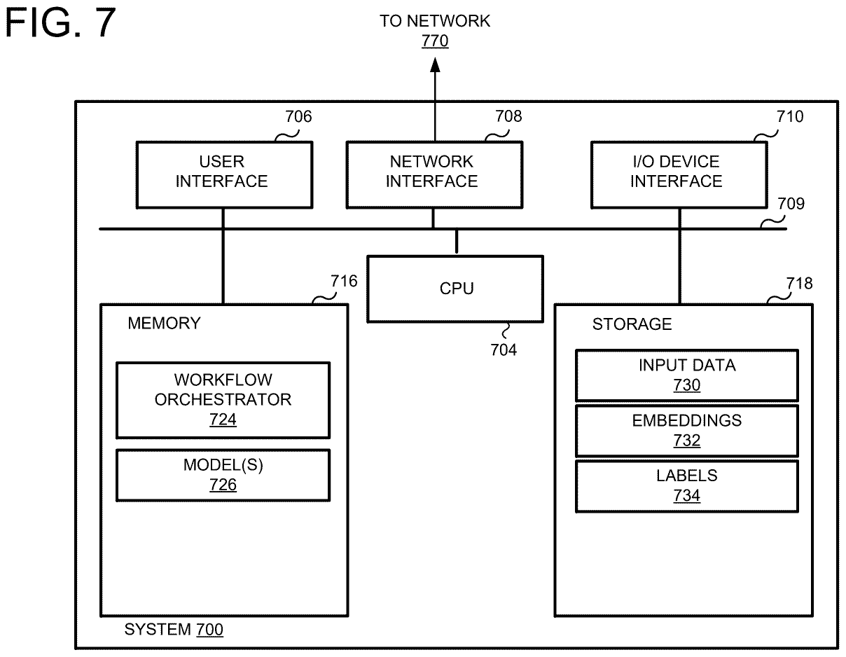

FIG. 7 is a diagram depicting an example computing system 700 related to automated workflow orchestration according to at least one embodiment.

Although depicted as a single physical device, in embodiments, computing system 700 may be implemented using virtual device(s), and/or across a number of devices, such as in a cloud environment.

As illustrated, computing system 700 includes a central processing unit (CPU) 704, memory 716, storage 718, a network interface 708, and one or more I/O interfaces 710.In the illustrated embodiment, CPU 704 retrieves and executes programming instructions stored in memory 716, as well as stores and retrieves application data residing in storage 718.CPU 704 is generally representative of a single CPU and/or GPU, multiple CPUs and/or GPUs, a single CPU and/or GPU having multiple processing cores, and the like. Memory 716 is generally included to be representative of a random-access memory. Storage 718 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, input and output (I/O) devices (such as keyboards, monitors, etc.) can be connected via the I/O interface(s) 710. Further, via network interface 708, computing system 700 can be communicatively coupled with one or more other devices and components. In certain embodiments, computing system 700 is communicatively coupled with other devices via a network 770, which may include the Internet, local network(s), and the like. The network may include wired connections, wireless connections, or a combination of wired and wireless connections. As illustrated, CPU 704, memory 716, storage 718, network interface(s) 708, and I/O interface(s) 710 are communicatively coupled by one or more interconnects 709.

In the illustrated embodiment, memory 716 includes a workflow orchestrator 724, which may perform functionality described above with respect to FIGS. 1-6. Memory 716 further includes one or more models 726, which may include machine learning model 210 of FIG. 2, language processing machine learning model 310 of FIG. 3, embedding model 410 of FIG. 4, and/or language processing machine learning model 510 of FIG. 5.

In the illustrated embodiment, storage 718 includes input data 730, which may include input data 202 of FIG. 2. Storage 718 further includes embeddings 732, which may include embedding 412 and/or label embeddings 422 of FIG. 4. Storage 718 further includes labels 734, which may include candidate labels 452 of FIG. 4 and/or selected label 512 of FIG. 5.

As is apparent from the foregoing general description and the specific aspects, while forms of the aspects have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method. or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a calculated resin” includes aspects comprising one, two, or more calculated resins, unless specified to the contrary or the context clearly indicates only one calculated resin is included.

While the foregoing is directed to aspects of the present disclosure, other and further aspects of the disclosure may be devised without departing from the basic scope thereof, and the scope thereof is determined by the claims that follow.

What is claimed is:

1. A method for autonomous orchestration of a data labeling workflow, comprising:
generating a prediction based on input data using a classification machine learning model;
performing, based on a confidence score associated with the prediction, a generative artificial intelligence process, comprising:
generating, using a generative machine learning model, a natural language description of the input data;
selecting a set of candidate labels based on the natural language description of the input data;
providing natural language descriptions of the set of candidate labels and the natural language description of the input data to a language processing machine learning model; and
assigning a label to the input data based on the language processing machine learning model outputting the label in response to the natural language descriptions of the set of candidate labels and the natural language description of the input data; and
performing an action based on the assigning of the label to the input data.

2. The method of claim 1, wherein the performing of the generative artificial intelligence process is based on determining that the confidence score associated with the prediction is below a threshold.

3. The method of claim 1, wherein the generating of the natural language description of the input data comprises prompting the generative machine learning model to generate the natural language description in a manner that adds context to the input data and uses human readable natural language.

4. The method of claim 1, wherein the assigning of the label to the input data is further based on determining that the label matches the prediction.

5. The method of claim 1, wherein the assigning of the label to the input data is further based on determining that the label does not match the prediction and receiving manual confirmation of the label.

6. The method of claim 1, wherein the performing of the action comprises one or more of:
updating a workflow of a computing application;
populating a variable; or
displaying content via a user interface.

7. The method of claim 1, wherein the selecting of the set of candidate labels based on the natural language description of the input data comprises:
generating an embedding of the natural language description;
comparing the embedding of the natural language description to embeddings of descriptions of a plurality of labels; and
selecting the set of candidate labels based on the comparing, wherein the set of candidate labels contains fewer than all of the plurality of labels.

8. The method of claim 1, further comprising:
generating an additional prediction based on additional input data using the classification machine learning model;
determining, based on a corresponding confidence score associated with the additional prediction exceeding a threshold, not to perform a corresponding generative artificial intelligence process for the additional input data; and
assigning a corresponding label to the additional data based on the additional prediction without performing the corresponding generative artificial intelligence process.

9. A method for autonomous orchestration of a data labeling workflow, comprising:
generating, using a generative machine learning model, a natural language description of input data;
identifying candidate labels that are semantically similar to the natural language description of the input data;
providing the candidate labels and the natural language description of the input data to a language processing machine learning model;
receiving an output from the language processing machine learning model in response to the candidate labels and the natural language description of the input data, wherein the output indicates a selected label from the candidate labels;
validating the output based on an alternative label determination technique; and
associating the selected label with the input data based on the validating.

10. The method of claim 9, further comprising receiving, from the language processing machine learning model, a natural language explanation of why the selected label was chosen.

11. The method of claim 9, wherein the validating comprises determining whether the selected label matches a label determined using the alternative label determination technique or whether the selected label is within a category associated with the label determined using the alternative label determination technique.

12. The method of claim 11, wherein the validating comprises providing the selected label to a user interface for manual review based on determining that the selected label does not match the label determined using the alternative label determination technique and that the selected label is not within the category associated with the label determined using the alternative label determination technique.

13. The method of claim 11, wherein the validating comprises associating an accuracy indicator with the selected label based on determining that the selected label does not match the label determined using the alternative label determination technique and that the selected label is within the category associated with the label determined using the alternative label determination technique.

14. A method for autonomous orchestration of a transaction classification workflow, comprising:
determining a predicted classification for a transaction using a classification model;
identifying candidate classifications for the transaction from a set of classifications based on a semantic comparison of a description of the transaction with descriptions of the candidate classifications;
using a language processing machine learning model to determine a selected classification from the candidate classifications for the transaction; and
associating the selected classification with the transaction based on comparing the selected classification with the predicted classification.

15. The method of claim 14, wherein the candidate classifications exclude one or more classifications from the set of classifications.

16. The method of claim 14, wherein the language processing machine learning model outputs the selected classification based on analyzing the descriptions of the candidate classifications and the description of the transaction.

17. The method of claim 14, further comprising generating the description of the transaction using the language processing machine learning model or a different generative machine learning model based on a prompt indicating that the description should be generated from a perspective of an expert in a particular domain.

18. The method of claim 17, wherein the particular domain is procurement of goods or services in a particular industry.

19. A method for autonomous orchestration of an item classification workflow, comprising:
identifying candidate classifications for an item from a set of classifications based on a semantic comparison of a description of the item with descriptions associated with the set of classifications, wherein the candidate classifications include a configured number of highest ranked classifications from the set of classifications based on rankings assigned from the semantic comparison;
using a large language model to determine a selected classification from the candidate classifications for the item;
associating the selected classification with the item; and
performing an action with respect to the item based on the associating.

20. The method of claim 19, wherein the performing of the action comprises one or more of:
displaying the item via a user interface;
recommending the item to a user;
determining pricing information associated with the item;
determining market information associated with the item; or
determining material information associated with the item.

21. The method of claim 19, further comprising utilizing parallel processing or multi-thread processing to determine a corresponding selected classification for a different item while determining the selected classification for the item.
